(19) United States
(12) Patent Application Publication
(10) Pub. No.: US 2015/0058096 A1
(43) Pub. Date: Feb. 26, 2015

(54) Method and System for Marketing Maturity Self-Assessment

(71) Applicant: Acxiom Corporation, Little Rock, AR (US)

(72) Inventors: William Clay, Conway, AR (US); Kristen Mougeot, Little Rock, AR (US); Brently Barrow, Little Rock, AR (US); Bridget Farris, Little Rock, AR (US); Steve Manatt, Little Rock, AR (US); Charles Zinsmeyer, Llano, TX (US)

(21) Appl. No.: 14/338,215

(22) Filed: Jul. 22, 2014

Related U.S. Application Data
(60) Provisional application No. 61/869,797, filed on Aug. 26, 2013.
(60) Provisional application No. 61/922,351, filed on Dec. 31, 2013.

(51) Int. Cl. G06Q 10/06

(52) U.S. Cl. CPC G06Q 10/06395
USPC 705/7.41

(57) ABSTRACT

A computerized method and self-assessment tool for measuring the marketing capability of an organization generates a marketing maturity quotient (MMQ) to provide feedback on maturity along a standardized scale. A body of knowledge (BOK) is used to provide a comparison between MMQ results for an organization and those of the average and leader organizations. The self-assessment tool may be used as part of a marketing campaign for an enterprise, wherein the campaign owner identifies prospects for the self-assessment; configures a campaign that includes a list of prospects at organizations that may desire to use the self-assessment tool; and sends automated invitations to those prospects.

### CROSS-REFERENCE TO RELATED APPLICATIONS

This application claims the benefit of U.S. provisional patent application No. 61/869,797, filed on Aug. 26, 2013, entitled “Marketing Maturity Model,” and U.S. provisional patent application No. 61/922,351, filed on Dec. 31, 2013, entitled “Marketing Maturity Snapshot.” Such applications are incorporated herein by reference in their entirety.

### STATEMENT REGARDING FEDERALLY SPONSORED RESEARCH OR DEVELOPMENT

Not applicable.

### BACKGROUND OF THE INVENTION

The present invention relates to computerized methods and systems for measuring the marketing capabilities of organizations, and in particular to a computerized system and method for marketing capability self-assessment by organizations.

A capability maturity model (CMM) is a model developed to measure the degree of formality and optimization of processes through the study of data gathered from the organization engaging in those processes. The term “organization,” as used herein, may include any type of business group or entity as well as various departments, teams, or other subsets of a business group or entity. The goal of a CMM is to objectively assess the capability or “maturity” of an organization. The first CMMs were developed at Carnegie Mellon University beginning in the 1980's for the purpose of evaluating the capability of software contractors working for the U.S. Department of Defense. An underlying insight upon which CMMs are based is that organizations mature their processes in successive stages, based on solving process problems in a specific order. Although CMMs were first developed and used to measure software development processes, they have since been applied to other fields, such as information technology (IT) service management processes. In addition, CMM principles have been applied to human resources and management processes in the development of “people” CMMs. The successful deployment of CMMs in these various areas has led to significant improvement in the measured processes by identifying the level of maturity and further by identifying those steps required in order for an organization to advance to a greater level of capability in the areas measured.

Still today, the Capability Maturity Model Integration (CMMI) capability framework administered by Carnegie Mellon University is required by many Department of Defense and government programs for government contracts, especially software development. A “capability framework” is a specific type of analytical tool that provides a common structure to measure the current performance of capabilities, identify desired performance, determine the gaps between current and desired performance, and perform a series of diagnostic and analytical tests to establish priorities for capability improvement. There are many capability frameworks in use today, both public and private. Each capability framework has its own advantages and disadvantages, which determine its suitability for a specific application.

The operational, organizational, financial, and technological capabilities that are required for global marketing efforts consume large amounts of capital, on-going operating expense, and human resources. It is not uncommon for large companies with global marketing efforts to expend over one billion U.S. dollars annually in total marketing expenditures. Given the high cost, business plans that seek additional investment in marketing capability creation will need to be economically justified, with business plans and specific strategic initiatives proposed that will achieve measurable improvements in marketing capability maturity with associated business results.

Although CMMs have been used in industry to achieve business improvement goals for decades, attempts to use CMMs for marketing analysis have been limited in their utility because they are not based on objective criteria. Further, the development and execution of a CMM assessment can be time-consuming and expensive, particularly for larger organizations. A self-assessment tool that allows CMM to be applied to marketing capabilities of organizations by individual users without expert assistance would be highly desirable, since a self-assessment tool for this purpose could be utilized more quickly and at lower cost than a full CMM analysis. In addition, a relatively simple, easy-to-use self-assessment tool would encourage organizations to perform this analysis, thereby urging them toward the development of more effective marketing processes within their organizations, and may further encourage them to perform a more complete marketing maturity analysis with the assistance of a professional assessor.

### BRIEF SUMMARY OF THE INVENTION

According to certain aspects of the subject matter described in this specification, a computerized self-assessment system and method is presented for measuring the marketing capability of an organization. A specific focus is marketing strategy and the data, business process, technology, people and organizational design required to implement the strategy. In certain embodiments, relevant data collected about the subject organization is received, and is used to measure maturity with respect to one or more key business challenges along with the organization's desired level of maturity improvement per business challenge over a particular timeframe, such as, for example, one year. A body of knowledge (BOK) for global, multi-channel, database marketing and advertising is used in order to provide relevant data. The data may be compared to data from a normative database that includes peer group averages and leaders to determine the level of business challenge maturity, and to define the marketing characteristics of average and leader organizations. The computerized self-assessment system and method incorporates a specific set of algorithms in order to create an objective, fact-based assessment based on self-reported data from the organization. It may be seen that the present invention fills a specific gap in business management, namely, that of measuring and improving the business effectiveness of the specific operational, organizational, financial, and technological capabilities required for global marketing in today's complex, multi-channel marketing ecosystem, and doing so with a relatively simple-to-use, self-assessment tool.

In certain embodiments, the present invention provides for (1) prioritizing a set of defined business challenges; (2) identifying the current level of marketing maturity for the attributes associated with those business challenges; (3) calculating a current level of maturity per business challenge by aggregating attribute maturity levels; (4) providing comparison to evidenced-based industry benchmarks; and (5) capturing the desired level of maturity improvement in a particular timeframe for each business challenge. Organizations may use this point-in-time capability self-assessment tool in various ways, for example: (1) conducting business-to-business email marketing campaigns to generate new revenue; (2) conducting in-person interactive assessments at marketing events like trade shows; (3) conducting multiple assessments for comparing internal prioritization ranking of business challenges across departments, regions, or lines of business (LOBs) to ensure prioritizations align; and (4) allowing a comparative view of an evidenced-based full marketing maturity model assessment of the subject organization to a self-assessment completed by the subject organization. The tool may also be made available on a website available to the public for purposes of marketing or general information. The tool may be used by either known or anonymous groups, including by way of example, executives of public and private corporations; technology, marketing, product, risk management, financial, and operations managers at organizations; account executives; consulting professionals; and agency professionals. Such persons may be within an organization and also extending to any organizations working in partnership with an organization.

These and other features, objects and advantages of the present invention will become better understood from a consideration of the following detailed description of certain embodiments and appended claims in conjunction with the drawings as described following:

### BRIEF DESCRIPTION OF THE SEVERAL VIEWS OF THE DRAWINGS

FIG. 1 illustrates an overall architecture for a preferred embodiment of the present invention.

FIG. 2A illustrates the comprehensive knowledge architecture for the marketing maturity model body of knowledge (BOK) according to an embodiment of the present invention.

FIG. 2B (composed of subparts 2B-1, 2B-2, and 2B-3) illustrates a data structure according to a preferred embodiment of the present invention.

FIG. 2C illustrates an overall process flow for an embodiment of the present invention.

FIG. 3 illustrates an example of an email message used in an automated end-to-end campaign according to an embodiment of the present invention.

FIG. 4 illustrates a screen display allowing end-users to prioritize their most pressing business challenges according to an embodiment of the present invention.

FIG. 5 illustrates a screen display with the attributes from the BOK that are associated with the user-selected business challenges according to an embodiment of the present invention.

FIG. 6 illustrates a screen display showing the end-user's selection of the level of maturity for the prioritized business challenges according to an embodiment of the present invention.

FIG. 7 illustrates a screen display showing the calculated level of maturity for the selected business challenges along with the average and leader benchmarks according to an embodiment of the present invention.

FIG. 8 illustrates a screen display showing the end-user's desired level of one-year capability improvement per prioritized business challenge according to an embodiment of the present invention.

FIG. 9 illustrates a first section of an example report that is provided to the campaign owner following a completed self-assessment according to an embodiment of the present invention.

FIG. 10 illustrates a second section of an example report that is provided to the campaign owner following a completed self-assessment according to an embodiment of the present invention.

FIG. 11 illustrates a screen display showing an example of aggregated prioritization of business challenges for a group of self-assessments by persons within a single organization.

FIG. 12 is a diagram of a computer system and network implementing the marketing capability self-assessment system and method according to an embodiment of the present invention.

### DETAILED DESCRIPTION OF THE PREFERRED EMBODIMENT(S)

Before the present invention is described in further detail, it should be understood that the invention is not limited to the particular embodiments described, and that the terms used in describing the particular embodiments are for the purpose of describing those particular embodiments only, and are not intended to be limiting, since the scope of the present invention will be limited only by the claims.

In various embodiments the present invention provides a capability self-assessment method using integrated software and reporting tools to provide a point-in-time prioritization of a set of defined business challenges. These embodiments enable an organization to identify the current level of marketing maturity for the associated business challenges for the purpose of comparing scores to internal or external peer groups of that organization. Internal peer groups may include benchmarks for products and performance, internal assessments, and internal company benchmarks. These various embodiments of the present invention enable the identification of specific business challenges in need of improvement, and allow the organization to determine what degree of improvement is needed. They provide for reporting on point-in-time capability versus benchmarks and improvement needed. The various embodiments described herein may be used, for example, in conducting business-to-business marketing campaigns to generate new revenue; conducting live, interactive marketing events at trade shows; a discovery process for internal comparisons in conjunction with a workshop through an individualized e-mail invitation; a comparative view of an evidenced-based full marketing maturity model assessment of the subject organization; and through a website such as hosted by a marketing services provider.

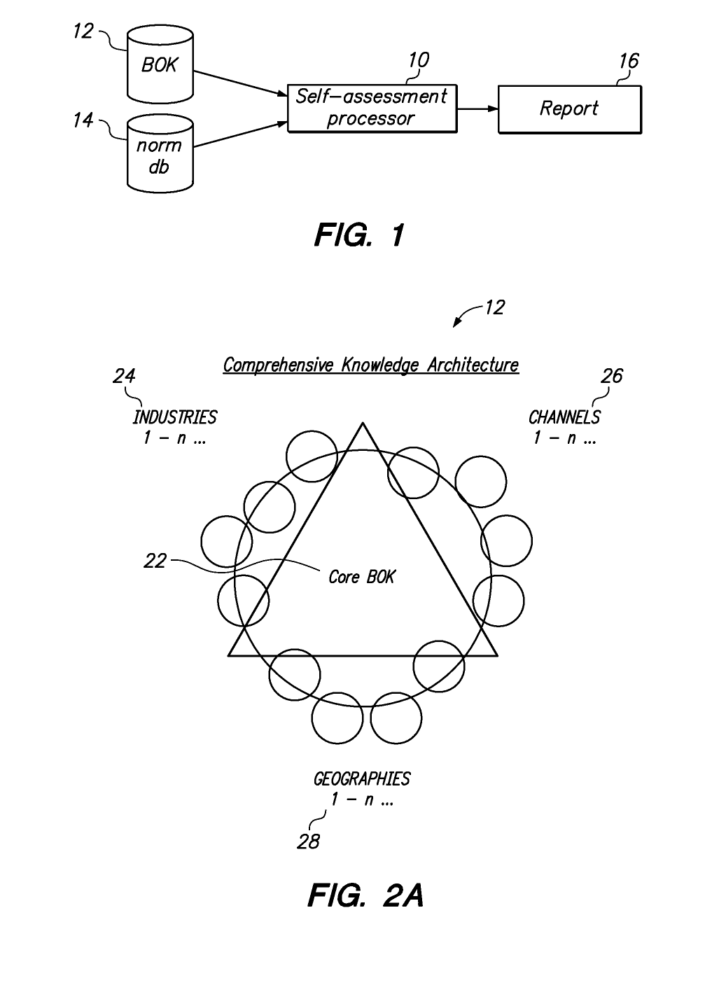

Referring now to FIG. 1, the basic architecture of an embodiment of the present invention may be described at a high level. Self-assessment processor 10 is computing hardware that has been programmed with specialized software in order to provide the specific self-assessment maturity model functions as described herein. Self-assessment processor 10 uses data drawn from a number of sources in the course of the processing provided by self-assessment processor 10. Such data includes body of knowledge (BOK) 12 and normative database 14, each of which will be more fully described below. Self-assessment processor 10 may be used in connection with a marketing campaign. A marketing campaign or just campaign, as used herein, refers to a marketing process of reaching out to consumers, including without limitation current customers and prospective customers. A campaign may be, for example, an automated process where specific and known users are targeted to receive a personalized message through one or more channels, such as email and direct mail. The purpose of a campaign is to generate interest in the products or services of the company that is sending the marketing message, and the message may contain a value proposition, such as a discount or special offer, and an associated call to action, such as a link to a website, a phone number, or an email address. Self-assessment processor 10 generates a report 16, as more fully described below. The various components of the system as shown in FIG. 1 may be integrated or may be implemented as physically separate components. The various components may communicate with each other over a local bus, a local area network (LAN), a wide area network (WAN), or any other communications network, including without limitation the Internet.

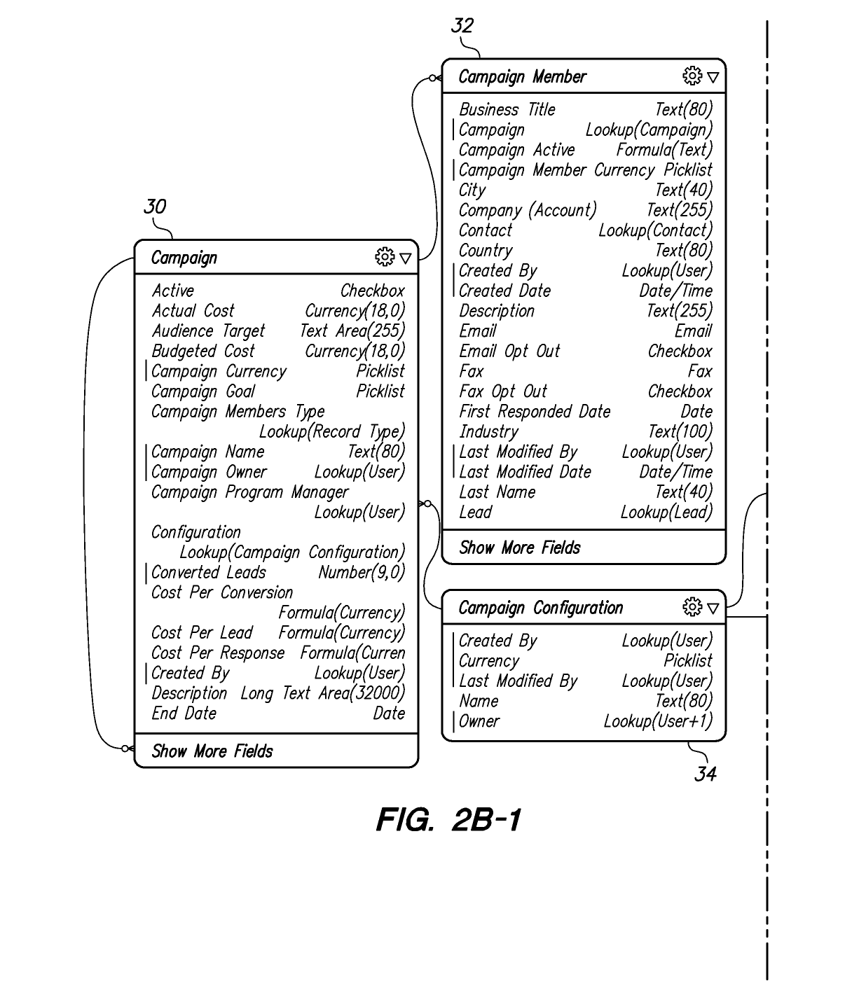

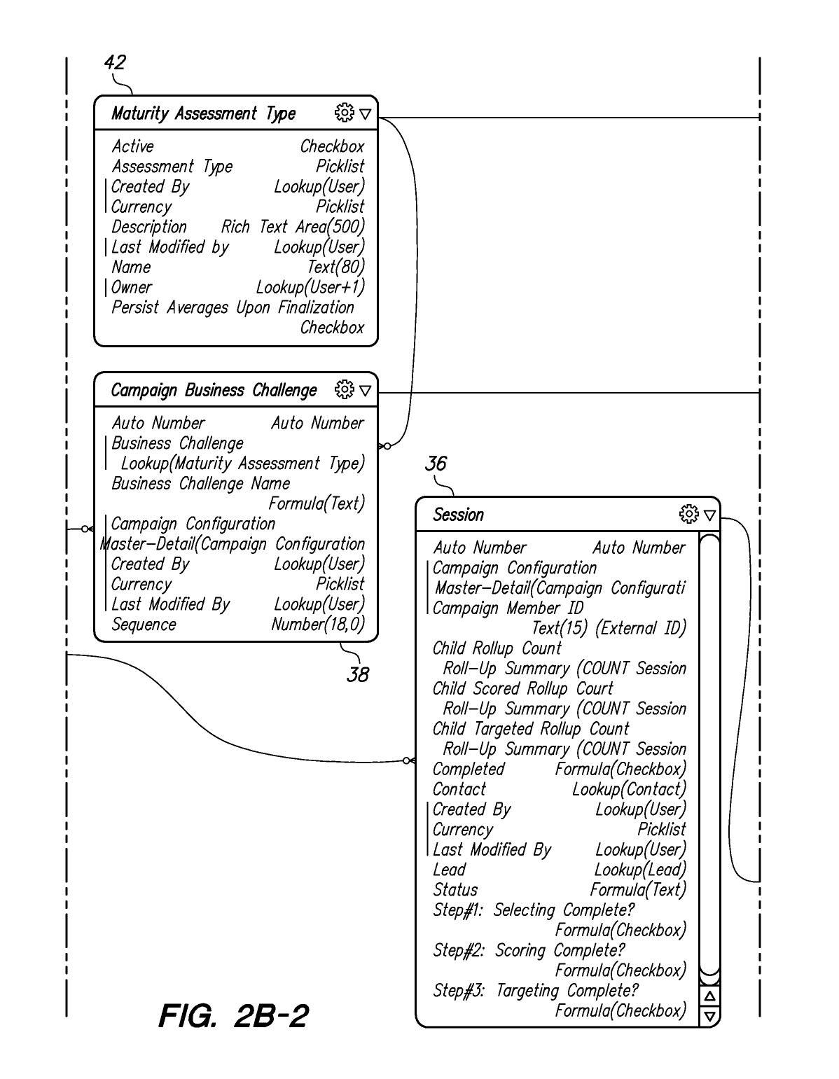

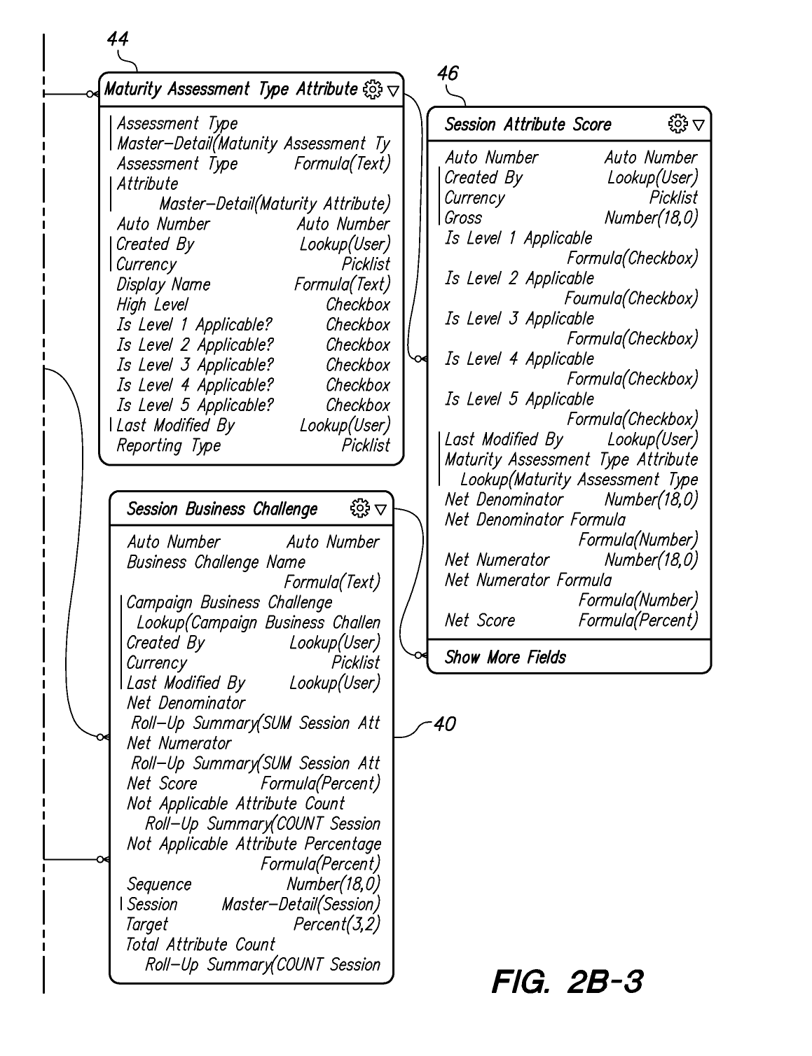

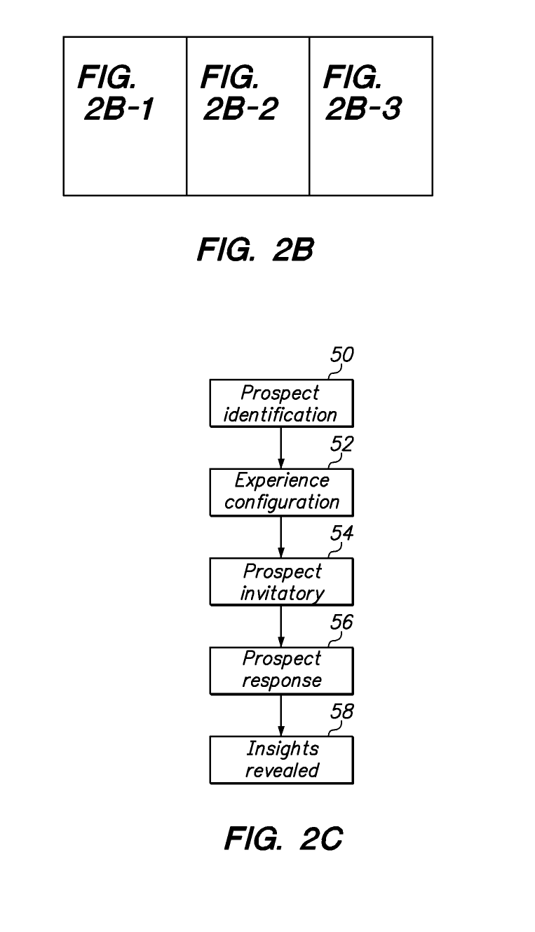

Referring now to FIG. 2A, a comprehensive knowledge architecture for the marketing maturity model BOK 12 may be described according to its general structure. BOK 12 contains the various business challenges that may be presented to an organization, in association with those business attributes that are associated with each of those challenges. An “attribute” is defined as an observable characteristic that can be measured for a particular organization in connection with a business challenge. At the center of the body of knowledge is core set 22, which includes each of the business challenges and attribute definitions and questions that make up the business function of database marketing and advertising. Surrounding this core set 22 is a set of industry knowledge 24, channel knowledge 26, and geography knowledge 28 that makes up the operational, organizational, financial, and technological capabilities required for activation of multi-channel database marketing capabilities necessary to meet the necessary business challenges. Taken together, this data makes up the comprehensive knowledge architecture for BOK 12. Industry knowledge 24 may be divided into retail, financial, and telecom, for example. Channel knowledge 26 may include various marketing channels, such as direct mail, email, and television. Geography knowledge 28 may be referenced to various geographic regions divided for marketing purposes, such as North America, Latin America, Asia-Pacific, and Europe-Middle East-Africa.

FIG. 2B is a visualization of the data structure for certain embodiments of the present invention. A campaign record 30 is maintained for each marketing campaign, which includes information such as the owner name, target audience, and campaign name. A campaign configuration record 34 is further maintained for each campaign record 30 in order to present information as part of the self-assessment configuration. Campaign configuration record 34 links to a set of campaign business challenge records 38, each of which contains information about a particular business challenge associated with the organization conducting the campaign. Also linked through campaign configuration record 34 is a session record 36, each corresponding to a particular session of use of the self-assessment by the campaign owner. Associated with each session record 36 is a set of session business challenge records 40, each corresponding to a particular business challenge that was identified by the organization representative in that session as a challenge that the organization wished to examine. Associated with each session business challenge record 40 is a session attribute score record 46, each tracking the attribute score for the associated business challenge of session business challenge record 40.

Also associated with each campaign record 30 is a campaign member record 32 for each member of the campaign. Campaign member record 32 contains information such as name, contact information, and industry for this particular campaign member. A maturity assessment type record 42 tracks the type of maturity self-assessment that is being performed in connection with a particular campaign business challenge. Maturity assessment type record 42 is linked to a maturity assessment type attribute record 44 for each attribute associated with that maturity assessment type. The maturity assessment type attribute records 44 are further linked to each session attribute score record 46 in order to supply the necessary data in order to track the session attribute scores associated with each of these records.

Normative database 14 preferably holds both the self-assessment response data as well as key pieces of information about the assessor. These additional pieces of information are beneficial for analyzing the data as a whole to derive valuable insights for both individual assessment comparisons as well as marketing trends. Normative database 14 is preferably dynamic, that is, the data stored in normative database 14 changes and is updated as assessments are performed for various companies; in certain embodiments, however, data from self-assessments is not used for benchmarking other assessments, but only for analytic purposes. In this way, the self-assessment tool may make use of the robust data set derived from professional assessment of a number of organizations, without a loss of accuracy that might occur from relying on self-assessment data entered by other organizations where that information has not been reviewed by a professional assessor. Normative database 14 thus allows for the calculation of industry benchmarks, mining for insights, and charting the evolution of an organization over time by comparing data of a particular organization against aggregate data of other organizations, such as by similar industry, and also by looking at changes for a particular organization over time. Normative database 14 facilitates identification of performance gaps between current state (“actual”) versus desired state (“expected” or “targeted”) performance. Through the analysis of specific marketing business challenges that organizations routinely face, the model provides organizations with a wider understanding of the root causes of the variance(s).

Information used to construct normative database 14 may include, at the highest level, two types of data: assessment scores by organizations, and organizational information, such as industry, location, geography, business description, financial performance and data, and performance metrics such as media spend. Using normative database 14, self-assessment processor 10 may generate a detailed report 16 that identifies an organization's most pressing business challenges. A goal of certain embodiments is the identification of shortcomings—or “gaps”—in an organization's marketing capability maturity. A “gap” is defined as the mathematical difference between the current state and target state with respect to particular business challenges. Target state represents the level that is required for the company to achieve its business objectives with respect to each business challenge. In certain embodiments, each attribute related to a business challenge is scored by means of self-assessment processor 10 from user input according to ranked levels. those levels are level 0 “not performed,” level 1 “performed,” level 2 “managed,” level 3 “standards,” level 4 “quantified,” and level 5 “optimizing.” As explained further below, an “n/a” score is also possible for each attribute. Individual organizations have unique planning cycles, and at any point in time may be in a different planning stage. Certain embodiments of the present invention accommodate this by providing that target business challenge goals may be established for, by way of example, a one-, two-, or three-year time horizon. Other time periods are possible in alternative embodiments.

FIG. 2C illustrates in overview the five primary steps associated with a self-assessment of an organization according to certain embodiments of the present invention. Those steps are prospect identification 50, experience configuration 52, prospect invitation 54, prospect response 56, and insights revealed 58. At prospect identification step 50, the leads or contacts are identified for purposes of directing the self-assessment invitation to a particular prospect. This step may vary depending upon the manner in which the self-assessment target is identified by the provider of the assessment system. This may be part of a general lead generation campaign in which, for example, emails are sent to a number of organization contacts who may be identified as potentially benefiting from the self-assessment system. Another option is for a personalized email invitation being sent in which recipients are invited to participate in a group workshop setting where the self-assessment tool will be available. Other options include presenting the self-assessment tool through a workstation available at a tradeshow booth, and simply providing access to the self-assessment tool on a website available to the public for access over the Internet. The end users of the self-assessment tool need not necessarily be personally identifiable in certain variations of this method; they may be anonymous or self-reported when the tool is accessed through a trade show event or the website of the company providing the self-assessment tool.

The first part of experience configuration 52 is to create or ensure an appropriate business challenge grouping exists for the desired self-assessment experience. A business challenge grouping is a reference to a set of specific business challenges (up to nine business challenges in certain embodiments) selected to specifically address the goal of the campaign. This configuration becomes a parameter on a self-assessment campaign. The next part of experience configuration 52 is campaign ownership configuration. Using the marketing campaign software tool, a marketing campaign is created and assigned a campaign owner. This information is stored at campaign record 30 as shown in FIG. 2B. The campaign owner is the person that will receive automated notification from the system once a self-assessment session is completed for each prospect. The campaign configuration, corresponding to campaign configuration record 34 as shown in FIG. 2B, consists of defining three specific parameters. The first parameter is a reference to a separate configuration for which business challenges are presented to the user. This configuration can consist of up to nine pre-defined business challenges, which in these various embodiments are groupings of specific attributes that speak to a targeted business focus. The second parameter, the campaign owner, is the internal person responsible for follow-up after a self-assessment is completed for an organization. This is a reference to a licensed system user who is active in the system. The third parameter defines the expected level of identification from the assessment tool's perspective. There are three possible values that correspond to known; unknown and required; and anonymous. All three parameters are preferably delineated for the self-assessment tool to function properly, and thus are set before invitations are sent at prospect invitation step 54.

In the next portion of experience configuration 52, and applying specifically to the case where the user of the self-assessment tool is known, the campaign is assigned a configuration that contains the list of selected business challenges from a number of pre-defined groupings of business challenges, along with the number of business challenges that are selectable by the end-user. Once the campaign is created and configured in this manner, the leads or contacts that were identified in prospect identification step 50 are added to the campaign using marketing campaign software, such as is available through salesforce.com (SFDC). In the case of anonymous users, such as a campaign that is created for a trade show or at the self-assessment tool owner's website, there may not be any pre-selected associated leads or contacts, but instead a user may be assigned a numeric record without identifiable contact information, if this information is not self-reported.

Turning now to prospect invitation 54, the end-user is invited to access the self-assessment tool in one of the four possible scenarios. In the end-to-end campaign scenario, the end-user is sent an automated yet personalized e-mail with a link to either a website that contains a link to the tool and other marketing materials or to the tool directly. In the workshop scenario, the end-user receives an e-mail from the campaign owner (not automated) containing a unique (to the user) or non-unique (multiple users) URL link to the self-assessment tool. In both the campaign and workshop scenarios, the end-user's identity is known and the end-user is specifically invited to participate. An end-user can also obtain access to the self-assessment tool through the tool owner's website by clicking a link to the tool as well as via a tradeshow booth by the use of a tablet or smart phone. In the tradeshow scenario, the business challenges chosen may be focused particularly not on a particular prospect, but rather to a particular industry that is associated with the tradeshow. In these two scenarios, the end-user will either be asked to provide identifiable information or proceed directly to the tool anonymously. The campaign's specific configuration controls the required level of identification. In the case of allowing anonymous access, the system creates a placeholder user record to which the response data is attached. For self-identification, the user is presented with an input form with the minimum number of fields needed to satisfy user creation. When the end-user clicks on the link at prospect invitation 54, he or she is taken to the on-line software tool to begin a self-assessment at prospect response 56. The user's interaction with the self-assessment tool is described in greater detail below.

Following the completion of the self-assessment, at insights revealed step 58 the campaign owner is notified, preferably by email, that his or her lead or contact has completed the self-assessment. The email notification preferably includes several links or sets of links. The first link is a view of the results that the prospect received once he or she completed the assessment. The second link is a link to insight report 16. Finally, a set of links is presented that are directed to documents that describe the characteristic of average and leader organizations for the self-assessor's selected business challenges.

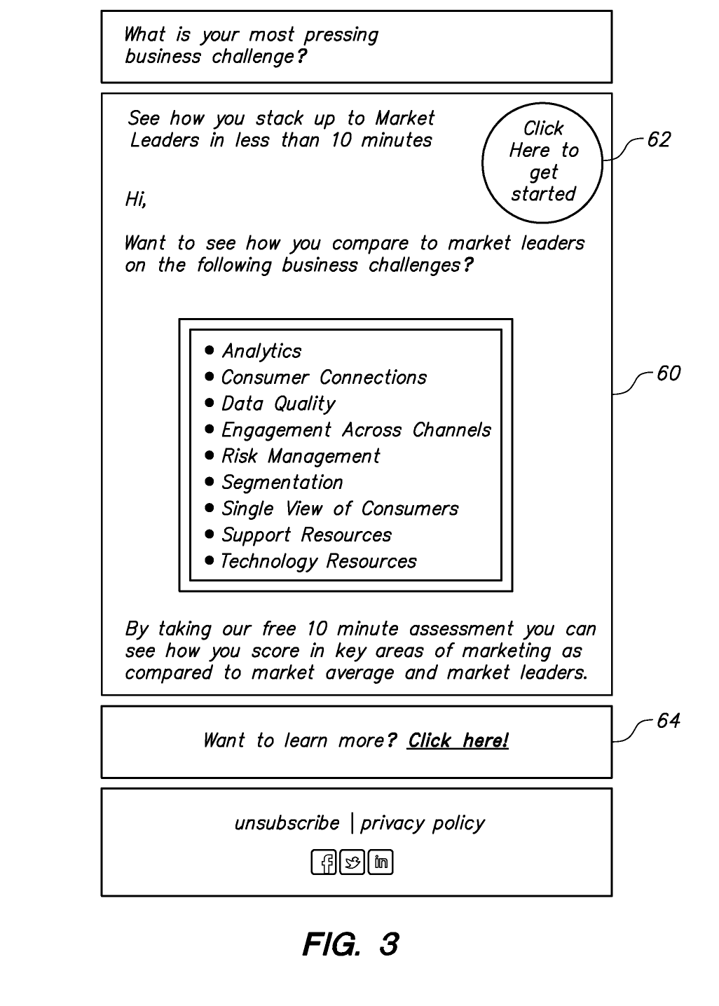

The steps according to various embodiments of performing a self-assessment having been described in overview, these steps may be treated in more detail following with reference to various displays visible to the user of the self-assessment tool. FIG. 3 illustrates a personalized email 60 that may be sent to a lead or contact during prospect invitation step 54. It may be seen that personalized email 60 contains two links. Self-assessment tool link 62 allows direct access to the self-assessment tool through a personalized link, that is, a link that is unique to each participant. This allows for the personalization of the self-assessment based on the parameters entered during experience configuration step 52. Since each link is unique to a particular lead or contact, the act of clicking upon self-assessment tool link 62 sends information to the self-assessment tool allowing for identification of the user. Further information link 64 allows the participant to gather more information about the provider of the self-assessment tool, the marketing maturity model, the self-assessment tool itself, or industry-specific literature (such as white papers). Further information link 64 thus allows a lead or contact to explore information about the self-assessment tool before beginning the assessment process. This link is tied to the campaign and therefore to this particular participant. The second link may lead the user to a landing page that is personalized for this particular campaign, or may contain general information that applies to multiple campaigns.

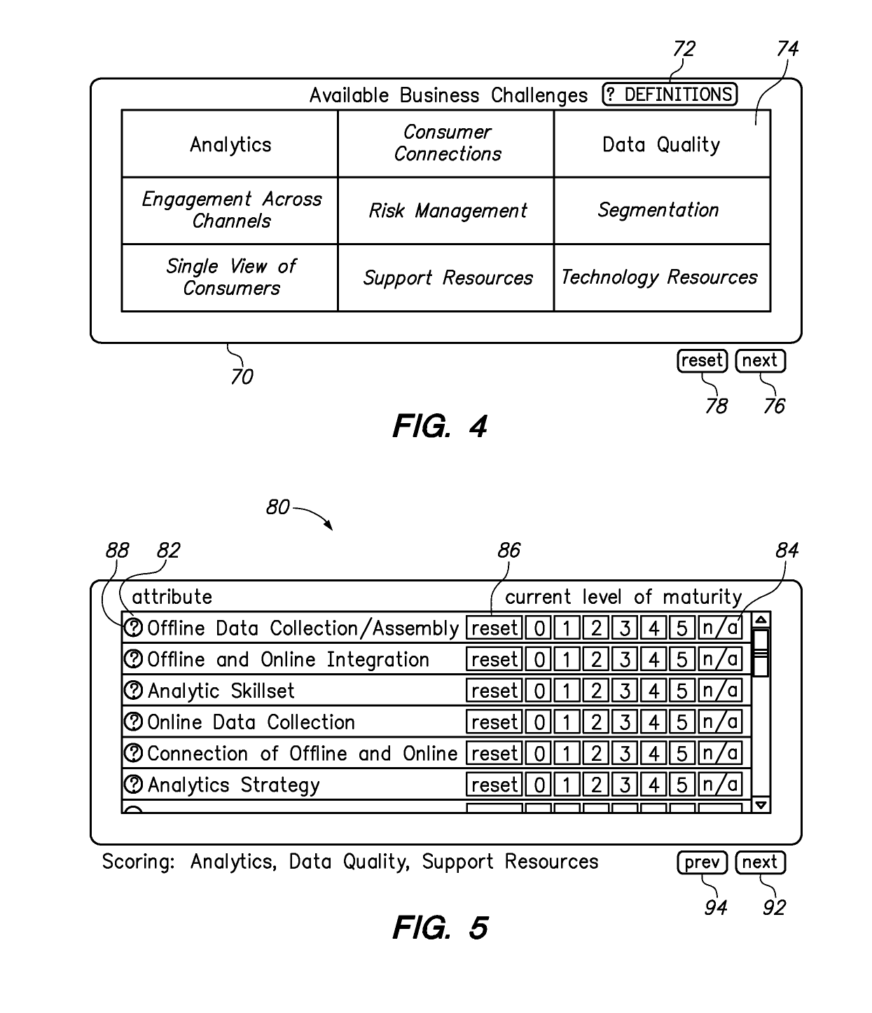

Once the user clicks on self-assessment tool link 62, the user is directed to a business challenge page 70, such as depicted in FIG. 4. In this example, business challenge page 70 presents the user with up to nine possible business challenges for which the self-assessment may be performed. Each of the business challenges are presented in a box that is in business challenge grid 74. A box is assigned to each business challenge in business challenge grid 74 for ease of visualization. During configuration, the campaign owner has been given the option of choosing up to nine pre-defined business challenges for application of the self-assessment tool to meet his or her campaign goals. In other embodiments of the invention, a different number of possible business challenges may be used, and/or a different number of business challenges may be chosen by the campaign owner for purposes of the self-assessment. The user may select the configured business challenges by simply clicking on the corresponding boxes for those business challenges, which preferably are shaded or change color to indicate the user's selection. In the preferred embodiment, the chosen boxes change color, and a prioritization number appears in the background of that box in business challenge grid 74, so that the user can easily visualize which business challenges have been chosen and the order that those business challenges have been assigned, which correlate to prioritization.

If the user desires further information about any of the business challenges presented on business challenge page 70, the user may click on definitions button 72. The result of doing so is the presentation of a user definitions page that presents the definitions of the proprietary set of business challenges used by the self-assessment tool. This information is stored in BOK 12, and is pulled from BOK 12 in order to populate the definitions page when definitions button 72 is clicked. The integration of business challenge definitions from BOK 12 aids the user in determining the prioritization of his or her organization's most pressing business challenges for purposes of optimizing the utility of the self-assessment.

Once the user has made the desired selections within business challenge grid 74, the user may click on the business challenge page next button 76 in order to move to the next stage of the process. If a mistake is made in selecting business challenges or the user changes his or her mind, the user may click on the business challenge page reset button 78 in order to restart this step of the process.

Once the user clicks the business challenge page next button 76, an associated attributes page 80 is displayed as illustrated in FIG. 5. This page presents the user with a list of attributes 82 that are associated with the business challenges that have been chosen. For each attribute 82, the user is presented with a series of ranking numbers 84 for that attribute, which correspond to levels of maturity within the organization with respect to that attribute 82. In certain embodiments, the possible ranks are from 0-5, with a “n/a” (“not assessing”) ranking also available if the user determines that this attribute is not applicable to his or her organization. The user must rank (or enter “n/a”) for each attribute 82 in order to proceed to the next step in the self-assessment process. If the user incorrectly enters a ranking, then the user may click attribute ranking reset button 86 in order to re-enter the ranking selection.

The user may access additional information about a particular attribute 82 by clicking on the attribute help button 88. If attribute help button 88 is clicked, the user is presented with an attribute ranking definitions page. The attribute ranking definitions page presents the definition of this particular attribute 82, and further explains what particular levels of maturity correspond to each of the level numerical rankings. This information is stored in BOK 12, and is pulled from BOK 12 in order to populate the attribute ranking definitions page when attribute help button 88 is clicked. The integration of attribute ranking definitions from BOK 12 aids the user in accurately identifying the level for each of the attributes being considered as are relevant to the most pressing business challenges for the user's organization.

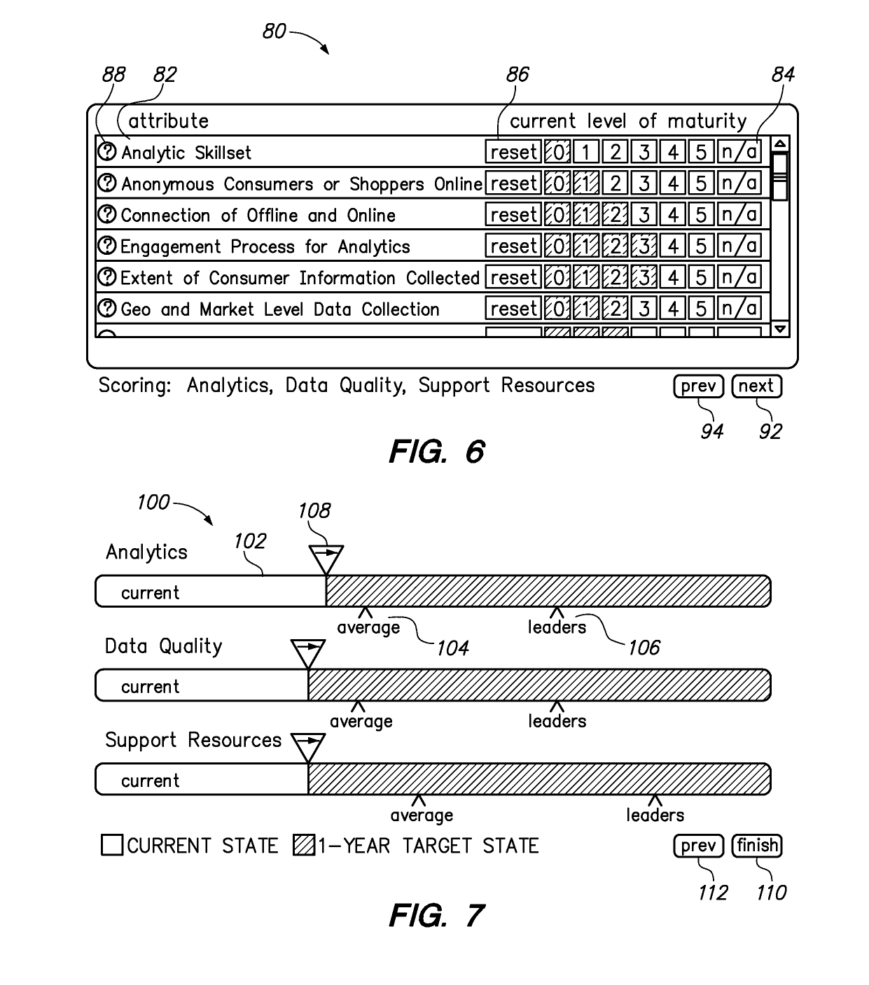

FIG. 6 illustrates the associated attributes page 80 in a particular example after the user has entered rankings for each of the listed attributes 82. In an embodiment, this is graphically illustrated by coloring or shading each of the levels up to the selected level for each attribute 82. The result is a level of maturity display. Once the user has entered a ranking or “n/a” for each attribute 82, the user may click on the attribute page next button 92 in order to move to the next stage of the process. If a mistake is made or the user changes his or her mind, the user may click on the attribute page previous button 94 in order to return to the previous step of the process.

After the user has scored the level of maturity for each of the attributes 82 on associated attributes page 80 and clicked the attribute page next button 92, the calculations are performed in order to determine a marketing maturity quotient (MMQ) for each of the selected business challenges. The calculation of an MMQ facilitates the understanding by a self-assessor of how the organization fares with respect to the identified business challenges. The use of MMQs allows for simple benchmarking of an organization's capabilities against other organizations overall or, for example, organizations in the same industry. For each attribute score, 0-5 in certain embodiments, an MMQ may be calculated by dividing the total attribute score for that business challenge by the maximum possible score, and then normalizing to a desired range, such as 0-100. Some attributes may have been scored “n/a,” as noted above. In the case of an “n/a” score for an attribute, that attribute is not considered in determining the total possible attribute score for calculating the MMQ. In order for a business challenge to receive an MMQ, however, 60% of the underlying attributes must have a current score of 0-5 in certain embodiments. Thus if a greater number of attributes receive an “n/a” score than this minimum, no MMQ is calculated for this particular business challenge.

Once the self-assessment processor 10 has completed the calculation of the MMQs for each business challenge identified, the user is then presented with slider bar display page 100, as illustrated in FIG. 7. For each of the selected business challenges, a slider bar 102 is graphically displayed showing the current maturity of the user's organization with respect to that business challenge. Preferably, this is shown by the use of different colors on the bar in order to provide clear visualization to the user. Slider bar 102 indicates the end-user's maturity level for the attributes 82 corresponding to that particular business challenge. Also depicted in connection with each slider bar 102 is the average MMQ marker 104 and leaders maturity marker 106. Average MMQ marker 104 graphically depicts the average maturity of organizations overall or within the same industry as the user's organization. Likewise, leaders MMQ marker 106 graphically depicts the maturity of the leader organizations. In an embodiment, “leaders” are defined as those organizations that are within the top 10% of completed maturity model assessments, but that definition can be varied in other embodiments of the invention. This information is maintained in normative database 14.

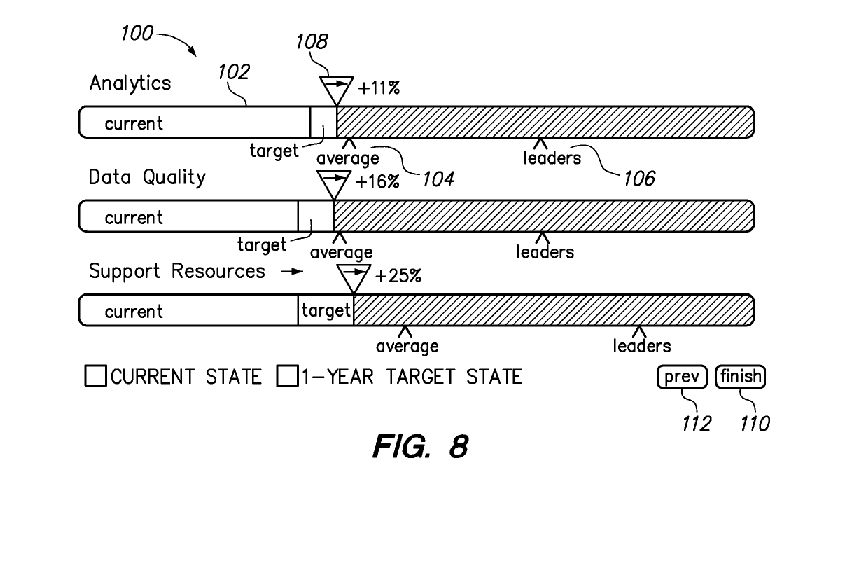

On slider bar display page 100, the user is requested to indicate how far the user wishes to advance the maturity of the user's organization in the next one-year period, or other designated period, with respect to each of the selected business challenges. This is accomplished by moving target slider 108 to the right. The result of moving target slider 108 for each of the displayed slider bars 102 is illustrated in FIG. 8 for a particular example. The percentage of improvement associated with each position of target slider 108 is displayed in proximity to target slider 108 as it is moved by the user. It may be understood then that slider bar display page 100 allows the user to easily visualize his or her organization's maturity with respect to each of the chosen business challenges, and compare that maturity to the leaders and the average, and also to visualize the user's goals for the organization within the next year in connection with the user's current maturity and the maturity of the leaders and average organizations.

Once the user has properly positioned each of target sliders 108 and completed viewing of slider bar display page 100, the user may click on the slider bar page finish button 110 in order to move to enter the results and view results of the self-assessment, as described below. If a mistake is made or the user changes his or her mind, the user may click on the slider bar page previous button 112 in order to return to the previous step of the process.

The user, after clicking on the slider bar page finish button 110, is presented with a results page presented in a format that is optimized for physical printing, and may also be sent in an email to the user (if the user's email address is known) so that the user may retain the results in this form. The self-assessment tool also preferably sends an automated email or other notification to the campaign owner that originally invited the user to perform a self-assessment, to let the campaign owner know that the self-assessment has been performed. The email notification preferably includes several links or sets of links. The first link is a view of the results that the prospect received once he or she completed the assessment. The second link is a link to insight report 16. Finally, a set of links is presented that are directed to documents that describe the characteristic of organization average and leaders for the self-assessor's selected business challenges.

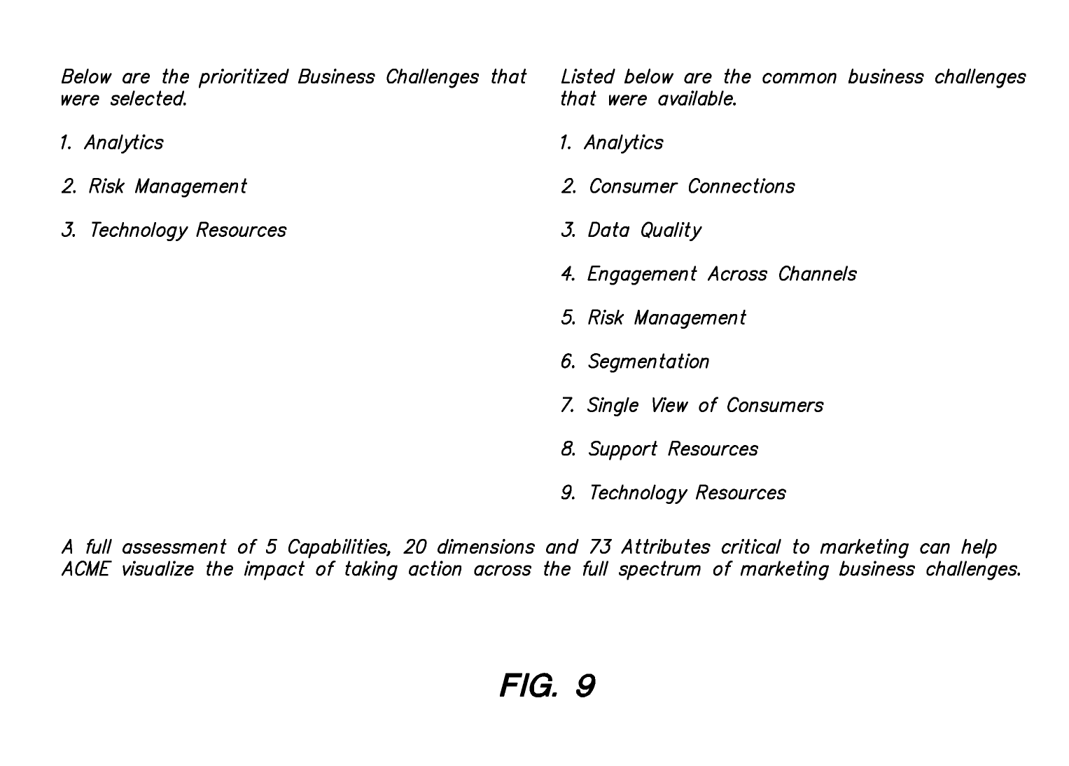

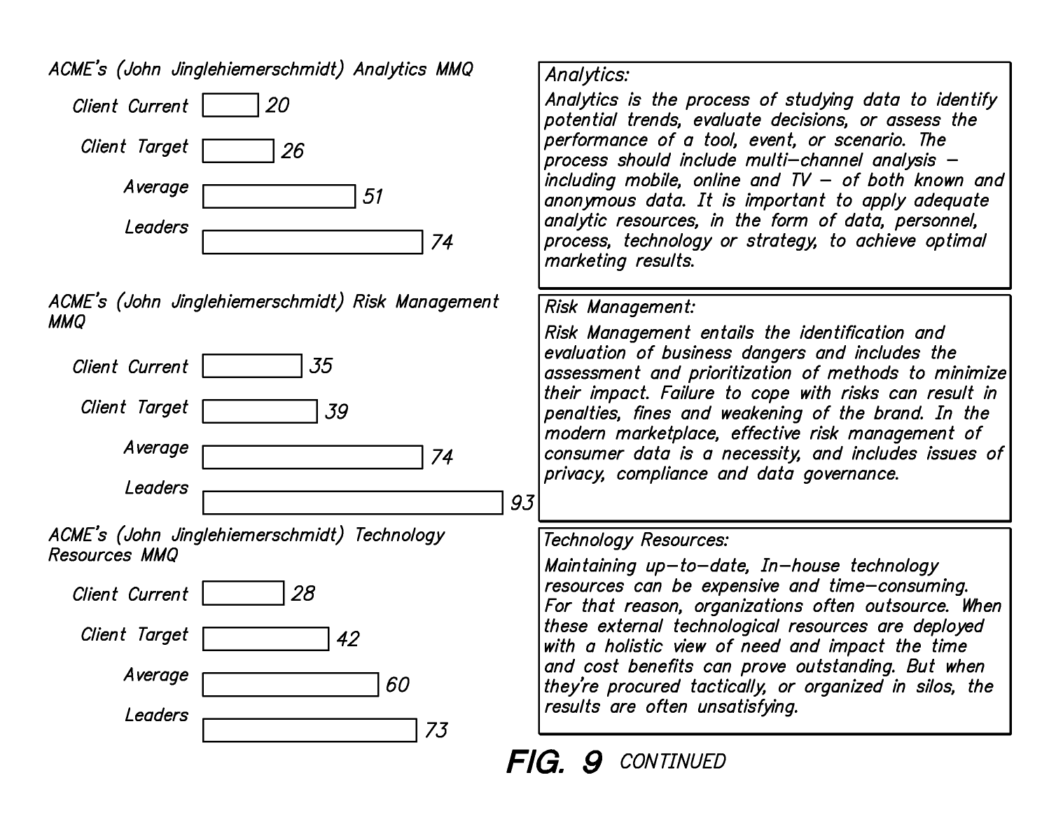

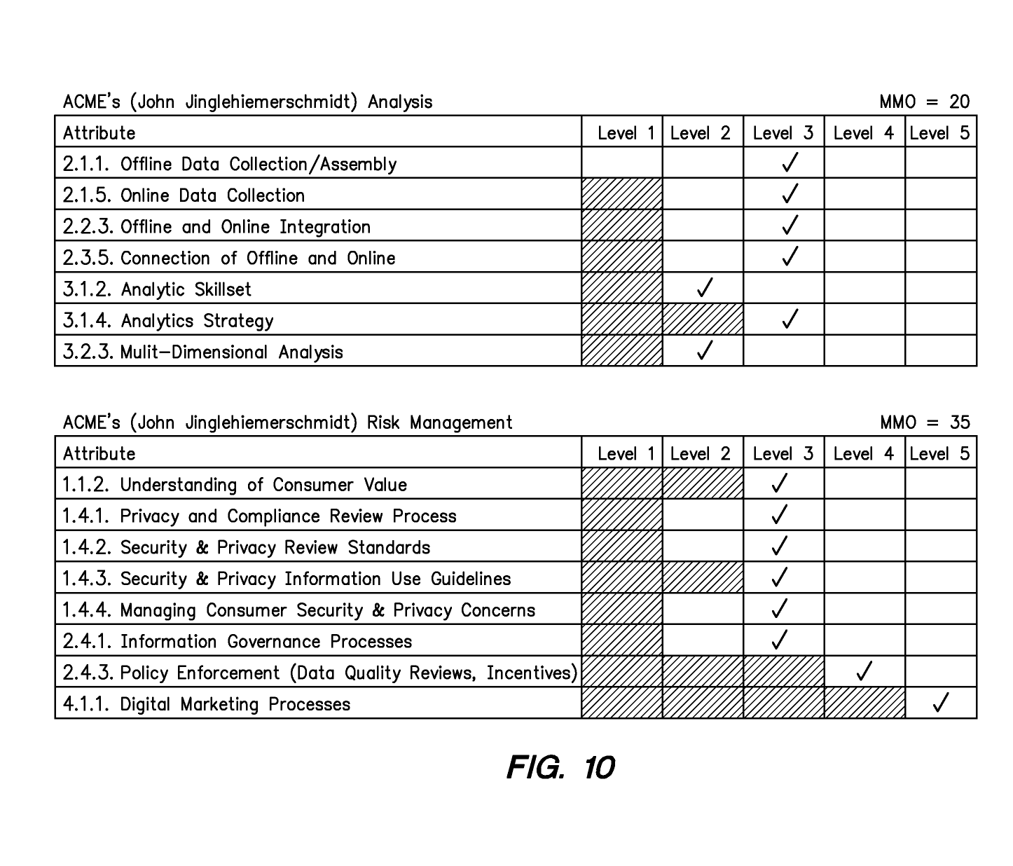

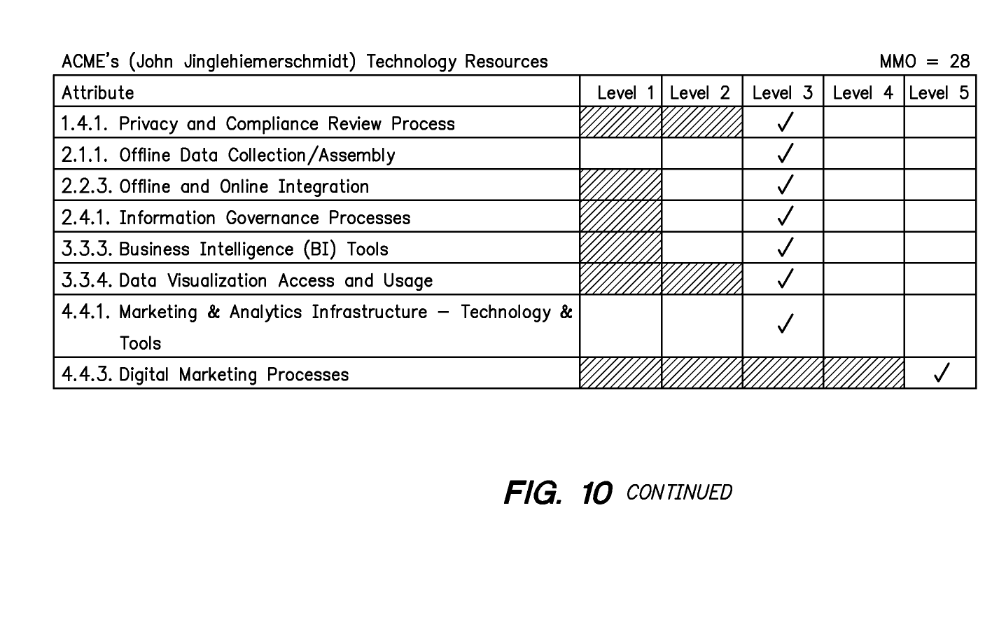

In various embodiments, report 16 contains three sections, illustrated by FIGS. 9 and 10. In the first section, the report lists the user-selected prioritized business challenges along with a full list of the set of defined business challenges from which the user selected. In the second section, the prioritized business challenges and their associated definitions are displayed along with the organization's aggregated current maturity level and derived target score, and the leader and average for each business challenge. This high-level perspective provides a visual report depicting the relative comparison between the participants current level of maturity and desired level of improvement, and the average and leaders. The second section of report 16, illustrated by the example of FIG. 10, further provides insight into the underlying attributes associated with each business challenge by using BOK 12 to provide a visualization that shows the participants current level of maturity for each attribute. Also depicted by a checkmark is the next level of maturity that must be obtained to significantly impact the organization's prioritized business challenge. Some check marks may not be in the next level higher from the current state due to the non-checked level being more foundational in the marketing capabilities for the business challenge than providing significant incremental improvement. This is because some levels must be passed in order to see actual business improvement associated with an increase in marketing maturity.

Report 16 may also, in various embodiments, include an analytics average and leader characteristics information. This information can be used to illustrate the differences between the user's view of average and leaders to evidence-based characteristics. This report may be useful to the campaign owner given the maturity level provided by the self-reporting by the user, since self-reporting often results in over scoring, and thus this information will provide a true picture of leader characteristics. For example, one characteristic for an organization with average analytics may be “analytic reports and dashboards are integrated into business planning processes at the company level with analytic metrics and measurements,” while the corresponding characteristic for an organization identified as a leader in analytics may be “predictive modeling and experimentation are introduced into decision processes to drive business performance improvement.”

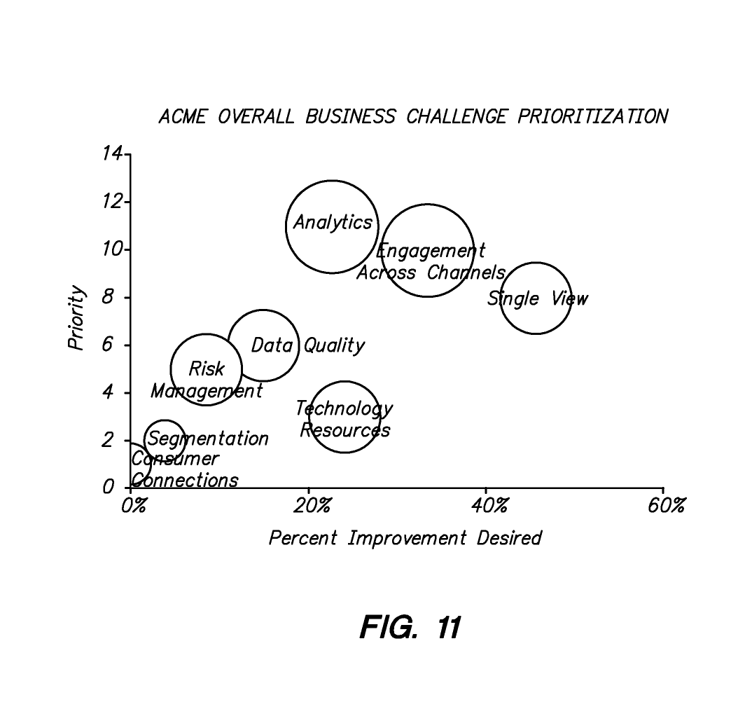

Report 16 may further include, in various embodiments and as shown by an example in FIG. 11, a display to a campaign owner of the results of a number of self-assessments by various users at the same organization. A ball chart may be used to visually map the users' selections at a particular organization, where, for example, the Y-axis may indicate the weighted prioritization of each business challenge, the size of each ball indicates the relative number of actual selections that business challenge received as one of the organization's most important challenges, and the position on the X-axis represents the aggregated level of improvement indicated per business challenge.

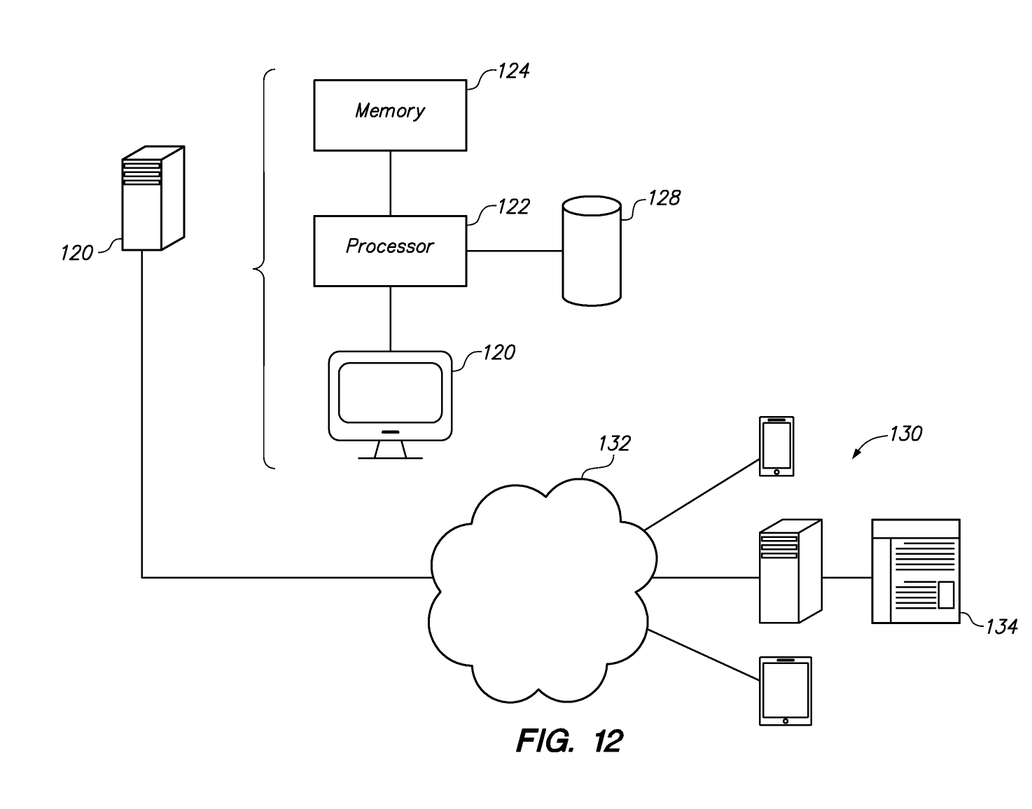

In certain embodiments the self-assessment system is implemented as a computing device 120 as illustrated in FIG. 12, which is programmed by means of instructions to result in a special-purpose computing device to perform the various functionality described herein. Computing device 120 may be implemented in a number of different forms. For example, it may be implemented as a standard computer server as shown in FIG. 12, or as a group of such servers. Computing device 120 may also be implemented as part of a rack server system, as are well known in the art. In addition, it may be implemented in a personal computer such as a desktop computer or a laptop computer.

Computing device 120 includes microprocessor or microprocessors 122, memory 124, an input/output device such as display 126, and storage device 128, such as a solid-state drive or magnetic hard drive. These components are interconnected, such as by bus, and may be mounted on a common PC board or separate PC boards.

Microprocessor 122 may execute instructions within computing device 120 that are stored in memory 124. Microprocessor 122 may be implemented as a single microprocessor, or may be implemented as a chipset that includes separate and multiple processors. Memory 124 may be implemented as one or more of a computer-readable medium or media, a volatile memory unit or units such as flash memory or random-access memory (RAM), or a non-volatile memory unit or units such as read-only memory (ROM). Memory 124 may be partially or wholly integrated within microprocessor 122. The invention in various embodiments may be implemented as a computer program product stored on a non-transitory tangible computer-readable medium in communication with a microprocessor or microprocessors, wherein the computer program product comprises instructions that may be loaded into the memory and executed at the microprocessor or microprocessors to achieve the functions described herein. Various implementations of the systems and methods described herein may be realized in digital electronic circuitry, integrated circuitry, computer hardware, firmware, software, and/or combinations thereof.

In the illustrated embodiment of FIG. 12, computing device 120 communicates with client computing device 130 over communications network 132, which may be a local area network (“LAN”), a wide area network (“WAN”), or the Internet. A user performing a self-assessment may utilize computing device 120 in order to access self-assessment processor 10 as implemented with computing device 120, and may also be used to review report 16. Client computing device 130 may be any type of computing device that is capable of accessing the Internet, including desktop computers, laptop computers, smartphones, and tablets. Client computing device 130 is preferably operable to run a web browser 134, such that a user at client computing device 130 may visualize information displayed at client computing device 130 that is transmitted from computing device 120. Client computing device 130 is further operable, through various components similar to those described with respect to computing device 120, to both send and receive information in order for the various functions and algorithms described herein to be performed at computing device 120.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. When a Markush group or other grouping is used herein, all individual members of the group and all combinations and subcombinations possible of the group are intended to be individually included. All references cited herein are hereby incorporated by reference to the extent that there is no inconsistency with the disclosure of this specification.

The present invention has been described with reference to certain preferred and alternative embodiments that are intended to be exemplary only and not limiting to the full scope of the present invention, as set forth in the appended claims.

1. A computer-implemented method for self-assessment of the marketing capability of an organization, comprising the steps of:
a. receiving at the processor a pre-defined configuration;
b. generating at a processor a set of business challenges based on the pre-defined configuration;
c. receiving at the processor a selection instruction selecting at least a subset of the set of business challenges;
d. retrieving from a body of knowledge (BOK) a plurality of attributes for each of the business challenges in the at least a subset of business challenges;
e. sending from the processor each of the plurality of attributes to a display;
f. receiving at the processor a current attribute maturity level for each of the plurality of attributes;
g. receiving at the processor a targeted desired state;
h. generating a report comprising an indicator of current maturity for each of the at least a subset of the set of business challenges and the targeted desired state.

2. The computer-implemented method of claim 1, further comprising the step of calculating at the processor a marketing maturity quotient (MMQ) for each of the business challenges.

3. The computer-implemented method of claim 2, wherein the step of calculating at the processor an MMQ comprises the steps of dividing a sum of the self-assessed levels for each of the plurality of attributes for each of the business challenges by a sum of a maximum possible level for each of the self-assessed levels for each of the plurality of attributes.

4. The computer-implemented method of claim 3, further comprising the step of accessing a normative database in communication with the processor to retrieve an average MMQ for each of the subset of business challenges, and wherein the report further comprises a comparison of the MMQ for each subset of business challenges to the average MMQ for that subset of business challenges.

5. The computer-implemented method of claim 4, further comprising the step of accessing the normative database to retrieve a leader MMQ for each of the subset of business challenges, and wherein the report further comprises a comparison of the MMQ for each subset of business challenges to the leader MMQ for that subset of business challenges.

6. The computer-implemented method of claim 3, wherein each of the MMQ for each of the subset of business challenges may comprise a not applicable value and wherein the step of calculating the MMQ for each of the subset of business challenges comprises the step of generating the not applicable value for each of the business challenges for which more than a threshold percentage of the associated plurality of attributes have the not applicable value.

7. The computer-implemented method of claim 6, wherein the threshold percentage is sixty percent.

8. The computer-implemented method of claim 3, further comprising the step of receiving at the processor a target MMQ for each of the plurality of business challenges, and wherein the report further comprises a target MMQ for each of the subset of business challenges.

9. A computer program product for self-assessment of the marketing capability of an organization, the computer program product being stored on a non-transitory tangible computer-readable medium in communication with a processor and comprising instructions that, when executed at the processor, cause the computer program product to:
a. generate a template for a marketing campaign comprising a plurality of prospects for a marketing maturity self-assessment;
b. provide to at least one of the plurality of prospects an invitation to use a self-assessment tool, wherein the invitation comprises a personalized link;
c. when a prospect of the plurality of prospects clicks on the personalized link, generate a business challenge page visible to the prospect comprising a set of business challenges from which the prospect may choose as a basis for subsequent self-assessment steps;
d. receive from the prospect at least a prioritized subset of the set of business challenges for self-assessment;
e. generate an associated attributes page comprising a list of attributes associated with the at least a subset of business challenges; and
f. receive from the prospect a score for each attribute.

10. The computer program product of claim 9, further comprising instructions that, when executed at the processor, cause the computer program product to calculate a marketing maturity quotient (MMQ) for each of the business challenges in the at least a subset of business challenges based on the score and correlated data in a body of knowledge (BOK).

11. The computer program product of claim 10, further comprising instructions that, when executed at the processor, cause the computer program product to generate a results page comprising the MMQ for each of the business challenges in the at least a subset of business challenges.

12. The computer program product of claim 11, further comprising instructions that, when executed at the processor, cause the computer program product to electronically transmit a message at the processor indicating that a self-assessment has been completed, wherein such message comprises a link to a set of results for the self-assessment.

13. The computer program product of claim 9, wherein the invitation comprises a personalized message to each of the plurality of prospects comprising a personalized link to a network location where a self-assessment tool may be accessed by the prospect.

14. The computer program product of claim 9, wherein the invitation comprises a personalized message to each of the plurality of prospects providing a specific page of a company website that offers the prospect a link to the self-assessment tool.

15. The computer program product of claim 9, wherein the invitation comprises a non-personalized but industry-specific message to each of the plurality of prospects providing a website comprising a link to the self-assessment tool.

16. The computer program product of claim 11, further comprising instructions that, when executed at the processor, cause the computer program product to generate a results page further comprising an average MMQ for each of the business challenges in the at least a subset of business challenges and a comparison between the MMQ for each of the business challenges in the at least a subset of business challenges and the average MMQ for each of the business challenges in the at least a subset of business challenges.

17. The computer program product of claim 16, further comprising instructions that, when executed at the processor, cause the computer program product to generate a results page further comprising a leader MMQ for each of the business challenges in the at least a subset of business challenges and a comparison between the MMQ for each of the business challenges in the at least a subset of business challenges and the leader MMQ for each of the business challenges in the at least a subset of business challenges.

18. A computerized tool for marketing maturity self-assessment, comprising:
a. a body of knowledge (BOK) stored in a non-transitory digital storage medium, the BOK comprising a plurality of marketing attributes and, for each attribute, further comprising a plurality of corresponding business challenges;
b. a normative database, the normative database comprising a set of marketing maturity quotients (MMQs) for each of a plurality of organizations;
c. a processor programmed by computer software stored on the digital storage medium and accessible in a memory in communication with the processor, the programmed processor comprising algorithms to receive a set of prospect business challenges from the plurality of business challenges, retrieve from the BOK a plurality of attributes for each of the prospect business challenges, send a set of attributes corresponding to each of the prospect business challenges, receive a level associated with each of the set of attributes, calculate a marketing maturity quotient (MMQ) for each of the selected set of business challenges, dynamically update the normative database with the MMQ for each of the selected set of business challenges, and generate a report identifying the MMQ for each of the selected set of business challenges.

19. The computerized tool of claim 18, wherein the programmed processor further comprises algorithms to retrieve from the normative database one or more of an average MMQ and a leader MMQ, and compare the MMQ for each of the selected set of business challenges with one or more of the average MMQ and the leader MMQ.

20. The computerized tool of claim 19, wherein each of the level associated with each of the attribute levels may comprise a not applicable value and wherein the programmed processor further comprises algorithms to calculate the MMQ for each of the selected set of business challenges as a not applicable value for which more than a set percentage of the associated attribute levels have the not applicable value.

21. The computerized tool of claim 20, wherein the set percentage is sixty percent.

22. The computerized tool of claim 18, wherein the programmed processor further comprises algorithms to generate a report identifying a target MMQ for each of the selected set of business challenges.
